(19) United States
(12) Patent Application Publication
(10) Pub. No.: US 2019/0307052 A1
(43) Pub. Date: Oct. 10, 2019

(54) FURROW OPENER WITH HEIGHT ADJUSTABLE TIP

(71) Applicant: Dutch Blacksmith Shop Ltd., Pilot Butte (CA)

(72) Inventor: Stuart Charles Stobbs, Birch Hills (CA)

(21) Appl. No.: 16/371,306

(22) Filed: Apr. 1, 2019

Related U.S. Application Data
(60) Provisional application No. 62/654,921, filed on Apr. 9, 2018.

(51) Int. Cl. A01B 49/06; A01C 5/06; A01C 7/20

(52) U.S. Cl. CPC A01B 49/06; A01C 7/206; A01C 5/062

(57) ABSTRACT

A furrow opener has an opener body with a mounting portion for mounting onto one of the tillage tool supporting shanks of an agricultural implement. A tip body that forms a furrow in the ground is supported on the opener body at a location which is downwardly and forwardly in relation to the mounting portion of the opener body. A product delivery passage on the opener body connects to a product delivery tube of the implement for delivery of a product therethrough into the furrow formed by the tip body. The tip body is coupled to the opener body so as to be adjustable in height relative to the opener body between a plurality of different mounted positions corresponding to different heights relative to the product delivery passage. One or more spacers may be mounted between cooperating faces on the opener and tip bodies in some of the mounted positions.

This application claims the benefit under 35 U.S.C.119(e) of U.S. provisional application Ser. No. 62/654,921, filed Apr. 9, 2018.

### FIELD OF THE INVENTION

The present invention relates to a furrow opener for being supported on a tool shank of an agricultural tillage implement, and more particularly the present invention relates to a furrow opener including an opener body for mounting on the tool shank and a tip body for forming a furrow in the ground in which the tip body is replaceable and is adjustable in height relative to the opener body.

### BACKGROUND

In a common structure of a furrow opener, an opener body is provided which is adapted to be fastened onto a tool supporting shank of an agricultural implement and a replaceable tip body is mounted at the leading side of the opener body for engaging the ground and forming the furrow as the implement is displaced across the ground. The replaceable tip body is typically mounted at a single fixed location on the opener body which is forward of a product delivery passage extending through the opener body for depositing product into the furrow being formed. As the replaceable tip body becomes worn, it is replaced.

In some instances, when the tip body comprises an elongate knife for forming a narrow furrow, for example when injecting liquid fertilizer into the ground, it is known to support the tip body through a range of different heights to control depth of the furrow. To ensure optimal placement of the fertilizer within the furrow, the application tube in this instance is typically fixed directly to the tip body for adjustment in height relative to the opener body together with the tip body. As the tip body becomes worn, it must be replaced in the usual manner of a wearable tip body as the discharge opening of the delivery tube gets closer to the bottom of the tip body as the bottom of the tip body wears away, resulting in plugging of the discharge opening. One example of an opener of this configuration in which the delivery tube is adjustable in height relative together with the tip body relative to the opener body is commercially available under the product name NH3 Fertilizer Knife by Atom Jet Industries, in Brandon, Manitoba, Canada.

### SUMMARY OF THE INVENTION

According to one aspect of the invention there is provided a furrow opener for an agricultural tillage implement having a plurality of tillage tool supporting shanks for being supported for movement across a ground surface in a forward working direction, the furrow opener comprising:

an opener body comprising a mounting portion adapted to be mounted onto one of the tillage tool supporting shanks of the implement;

a tip body supported on the opener body at a location which is downwardly and forwardly in relation to the mounting portion of the opener body so as to be adapted to form a furrow in the ground surface when displaced across the ground in the forward working direction; and

a product delivery passage on the opener body for connection to a product delivery tube of the implement for delivery of a product therethrough into the furrow formed by the tip body;

the tip body being coupled to the opener body so as to be adjustable in height relative to the opener body between a plurality of different mounted positions;

each mounted position corresponding to a different height of the tip body relative to the product delivery passage on the opener body.

By adjusting the height of the tip body relative to the product delivery passage on the opener body, the tip body can be lowered as the bottom end of the tip body wears away from use. In this manner, the optimal spacing between the discharge opening of the delivery passage and the bottom of the tip body can be maintained even as the tip body wears away to get much longer overall use out of the tip body before replacement is required.

The tip body may comprise a vertical knife shaped body. In this instance, the knife shaped body may comprise a pair of side surfaces which are flat and parallel to one another at opposing sides of the tip body. In some instances, when dispensing a granular product, the side surfaces of the knife shaped body may be located at a spacing which is less than a diameter of the product delivery passage such that a pair of rear protrusions which protrude laterally outwardly from rear edges of the pair of side surfaces respectively provide wear protection for the product delivery passage. In other instances however, such as when dispensing a liquid product, the product delivery passage may have a smaller diameter that equal to or less than the spacing between the side surfaces of the knife shaped body so that rear protrusions are not required or relied upon to the same degree.

The knife shaped body may also include a pair of upper protrusions which protrude laterally outwardly from the pair of side surfaces respectively which are adapted to abut a corresponding face on the opener body in an uppermost one of the mounted positions of the tip body relative to the opener body.

When the opener body comprises a receptacle portion receiving an upper portion of the tip body longitudinally slidable therein between the different mounted positions of the tip body relative to the opener body, a rear wall of the receptacle may include fastener apertures therein so as to be adapted to be fastened to the tool shank therethrough.

The tip body preferably includes an intermediate shoulder formed thereon which is adapted to abut the mounting face of the opener body in an uppermost one of the mounted positions of the tip body relative to the opener body.

The opener body may further comprise a supporting portion extending downwardly and rearwardly from the receptacle portion which supports the product delivery passage thereon.

When the tip body includes a plurality of retainer slots formed at longitudinally spaced positions along an exterior surface of the upper portion of the tip body and the opener body includes a retainer aperture extending through the opener body, the retainer aperture is preferably aligned with a respective one of the retainer slots in each of the mounted positions of the tip body relative to the opener body.

A retainer pin preferably extends through the retainer aperture in the opener body such that at least a portion of the retainer pin is received within the respective retainer slot in the tip body in each of the mounted positions of the tip body relative to the opener body. A cross section of the pin may be only partly received within the respective retainer slot in the tip body in each of the mounted positions of the tip body relative to the opener body.

The retainer pin may further include a latch member pivotally coupled at one end thereof for pivotal movement between a latched position in mating connection with a portion of the opener body so as to prevent sliding removal of the retainer pin from the retainer aperture and an unlatched position in which the retainer pin is slidably removable from the retainer aperture.

According to a second aspect of the present invention there is provided a furrow opener for an agricultural tillage implement having a plurality of tillage tool supporting shanks for being supported for movement across a ground surface in a forward working direction, the furrow opener comprising:

an opener body comprising a mounting portion adapted to be mounted onto one of the tillage tool supporting shanks of the implement and a receptacle portion;

a tip body adapted to be supported on the opener body through a range of mounted positions corresponding to different heights of the tip body relative to the opener body;

the tip body comprising (i) a lower portion adapted to form a furrow in the ground surface when displaced across the ground surface in the forward working direction, (ii) an upper portion which extends longitudinally upward from the lower portion and which is adapted to be received within the receptacle portion of the opener body throughout the range of mounted positions of the tip body on the opener body, and (iii) an intermediate shoulder oriented transversely to the upper portion at a junction of the upper portion and the lower portion which is adapted to abut a corresponding mounting face of the opener body in an uppermost one of the mounted positions of the tip body relative to the opener body; and

a spacer adapted to be releasably mounted onto the upper portion of the tip body in abutment between the intermediate shoulder on the tip body and the mounting face of the opener body in one of the mounted positions of the tip body relative to the opener body which is different from the uppermost one of the mounted positions.

The spacer may comprise a collar which extends about the upper portion of the tip body and which is slidably removable over a top end of the upper portion of the tip body when the tip body is separated from the opener body.

According to another aspect of the present invention there is provided a furrow opener for an agricultural tillage implement having a plurality of tillage tool supporting shanks for being supported for movement across a ground surface in a forward working direction, the furrow opener comprising:

an opener body comprising a mounting portion adapted to be mounted onto one of the tillage tool supporting shanks of the implement and a receptacle portion;

a tip body adapted to be supported on the opener body through a range of mounted positions corresponding to different heights of the tip body relative to the opener body;

the tip body comprising (i) a lower portion adapted to form a furrow in the ground surface when displaced across the ground surface in the forward working direction, (ii) an upper portion which extends longitudinally upward from the lower portion and which is adapted to be received within the receptacle portion of the opener body throughout the range of mounted positions of the tip body on the opener body, and (iii) a plurality of retainer slots formed at longitudinally spaced positions along an exterior surface of the upper portion of the tip body;

a retainer aperture extending through the opener body, the retainer aperture being aligned with a respective one of the retainer slots in each of the mounted positions of the tip body relative to the opener body; and

a retainer pin extending through the retainer aperture in the opener body such that a cross section of the pin is only partly received within the respective retainer slot in the tip body in each of the mounted positions of the tip body relative to the opener body.

Preferably the retainer aperture extends laterally through the opener body perpendicularly to the forward working direction.

Preferably the retainer slots are formed in a front face of the upper portion of the tip body.

### BRIEF DESCRIPTION OF THE DRAWINGS

Various embodiments of the invention will now be described in conjunction with the accompanying drawings in which:

FIG. 1 is a perspective view of the furrow opener showing a top side and a front side of the opener;

FIG. 2 is another perspective view of the furrow opener showing a bottom side of the opener;

FIG. 3 is a side elevational view of the furrow opener;

FIG. 4 is a front elevational view of the furrow opener;

FIG. 5 is a front elevational view of the tip body shown separated from the opener body of the furrow opener;

FIG. 6 is a perspective view of the separated tip body;

FIG. 7 is a perspective view of the opener body with the tip body removed therefrom;

FIG. 8 is a partly section view of the opener body with the tip body removed therefrom;

FIG. 9 is a side elevational view of the furrow opener with the tip body shown at a different height relative to the opener body than in FIG. 3; and

FIG. 10 is another side elevational view of the furrow opener with additional support collars shown supported on the tip body at the different height of the tip body according to FIG. 9.

In the drawings like characters of reference indicate corresponding parts in the different figures.

### DETAILED DESCRIPTION

Referring to the accompanying figures there is illustrated a furrow opener generally indicated by reference numeral 12 which is adapted to be supported on an agricultural tillage implement.

The tillage implement typically comprises a frame adapted to be coupled to a towing vehicle such as an agricultural tractor for movement across the ground in a forward working direction in use, and a plurality of tillage tool supporting shanks supported on the frame. Each tool shank 14 extends downwardly and forwardly from a mounting location on the frame towards a bottom end which is sloped downwardly and forwardly into the forward working direction.

The furrow opener 12 includes an opener body 16 adapted to be mounted onto one of the tillage tool supporting shanks of the implement, and a tip body 18 which is supported on the opener body at a location which is downwardly and forwardly in relation to the mounting location of the opener body on the tool shank. The tip body is adapted to form a furrow in the ground when displaced across the ground in the forward working direction of the implement.

The opener body 16 also supports a product delivery body 19 at a location rearwardly of the tip body 18 which defines a hollow product delivery passage extending longitudinally therethrough from a top end at a location spaced rearwardly of the mounting location of the opener body on the tool shank to a bottom in trailing relationship with the tip body for depositing material into a furrow formed in the ground by the tip body.

The tip body in this instance comprises a knife shaped body which is elongate in a longitudinal direction between a forward apex at a bottom end and an opposing top end. More particularly, the tip body includes a lower portion 20 which defines the knife shape of the tip which is adapted to form a furrow in the ground when displaced with the implement in the forward working direction across the ground. An upper portion 22 of the tip body extends longitudinally upward from the top of the lower portion for being received within a receptacle portion 24 of the opener body as described in further detail below.

The lower portion 20 in the mounted position is sloped to extend upwardly and rearwardly from the forward apex at the bottom end. The leading edge 26 is generally straight and upright in orientation so as to be oriented at an acute angle at the forward apex with a bottom side of the tip body. The lower portion comprises two flat side surfaces 28 occupying the majority of the laterally opposing sides of the lower portion of the tip body which are parallel and spaced apart from one another. The side surfaces extend rearward from opposing sides of the leading edge towards an upright rear edge of the lower portion of the tip body.

Two rear protrusions 30 are mounted at laterally opposing sides of the lower portion of the tip body in proximity to the rear edge so as to protrude laterally outwardly relative to the side surfaces 28 respectively. Each protrusion 30 is elongate in the longitudinal direction of the tip body and includes a flat rear surface which is generally flush with the rear edge of the lower portion of the tip body. At the front side, each rear protrusion 30 is generally ramped or wedge-shaped so as to be sloped rearwardly and laterally outwardly from the front side to the rear side of the protrusion.

When used for dispensing a granular product, an overall width of the lower portion of the tip body as defined by the side surfaces 28 is less than a diameter of the product delivery passage defined through the body 19; however, the overall width in the lateral direction at the rear protrusions is increased so as to be greater than interior diameter of the product delivery passage. In this manner the product delivery body 19 defining the passage therein is partly shielded by the rear protrusions 30 from wear as the tip body is displaced forwardly through the ground to form a furrow.

Although less essential when used for dispensing liquid product so that the product delivery passage is less in diameter than the spacing between the side surfaces 28, the rear protrusions in this instance remain useful to some degree in assisting in reducing wear to the body 19 defining the product delivery passage therein.

The lower portion of the tip body also includes two upper protrusions 32 which again protrude laterally outwardly from the two side surfaces 28 respectively but which are located at the top end of the lower portion to define an upper shoulder 34 lying perpendicular to the longitudinal direction of the tip body at the junction between the upper portion and the lower portion thereof.

The upper portion of the tip body is generally rectangular in cross section having two side surfaces which are spaced apart by the same width as the side surfaces 28 of the lower portion. A front edge 36 of the upper portion is stepped rearwardly in relation to the leading edge 26 of the lower portion of the tip body to define an upper shoulder 38 between the leading edge 26 of the lower portion and the front edge 36 of the upper portion. The upper shoulder 38 is also perpendicular to the longitudinal direction of the tip body while being coplanar with the upper shoulders 34 at the sides of the tip body such that the shoulders are collectively U-shaped around the front end of both sides of the upper portion of the tip body.

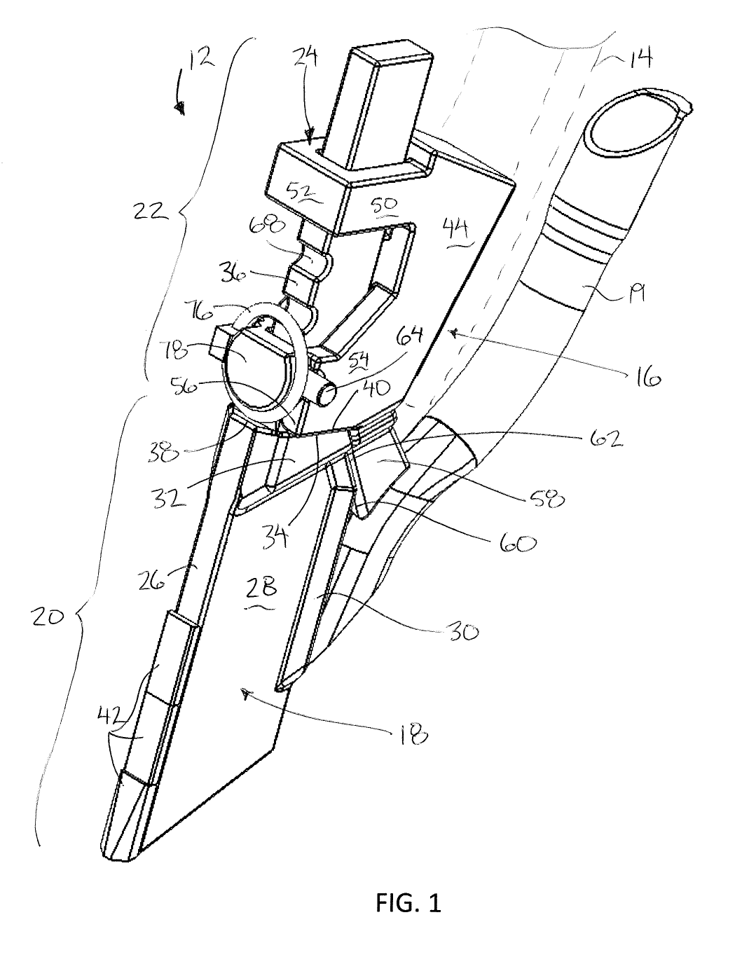

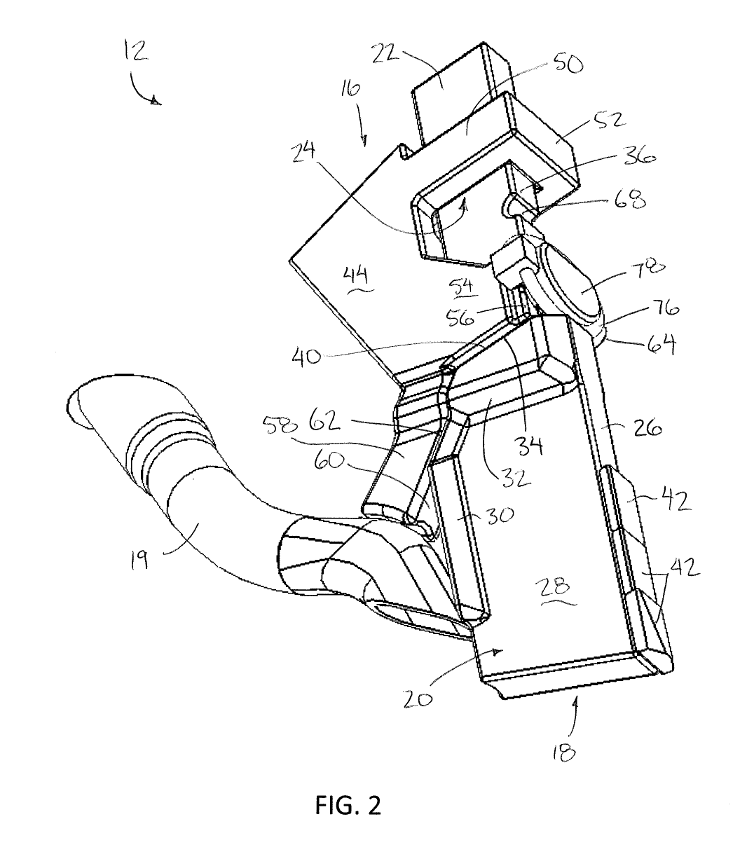

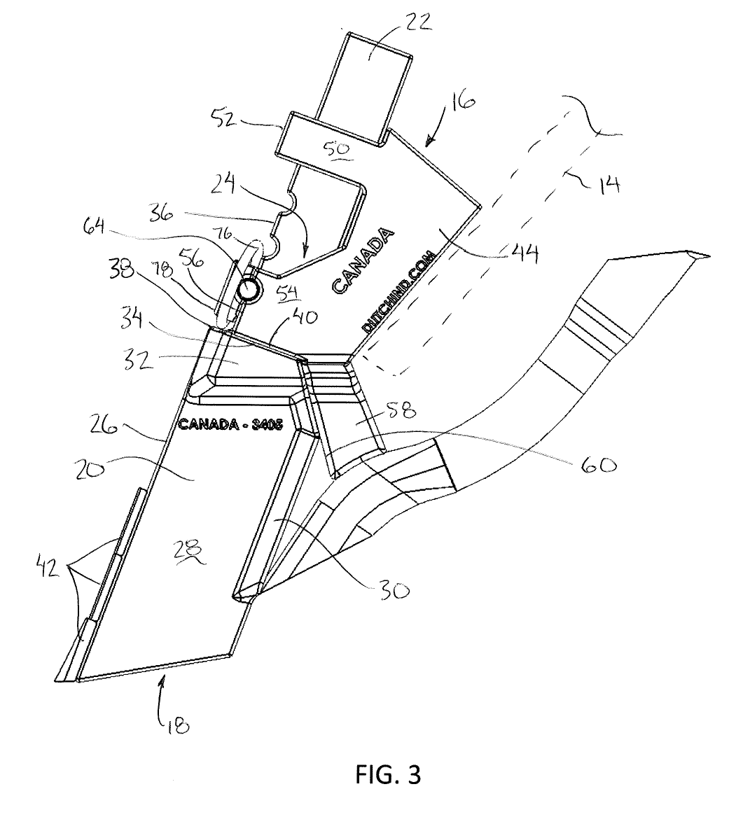

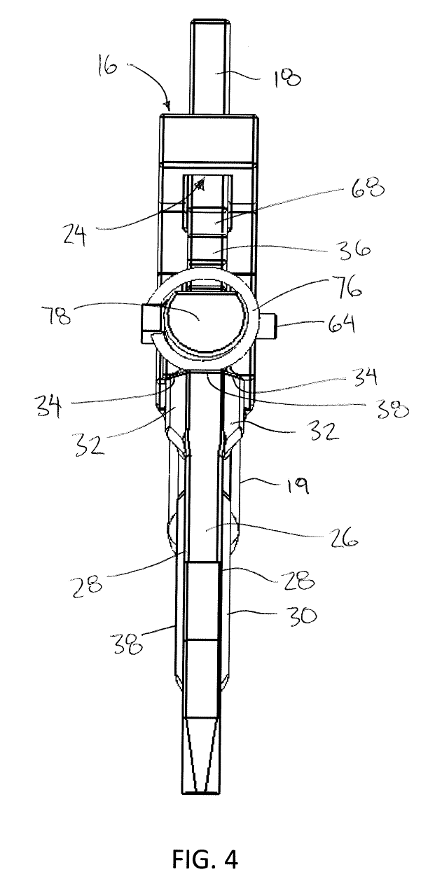

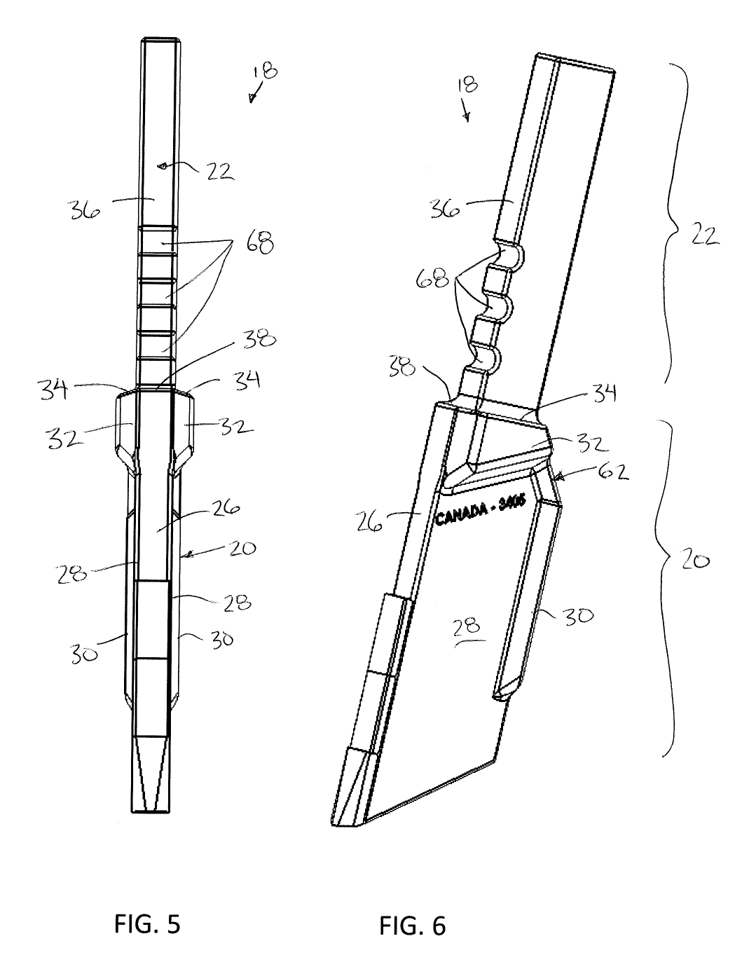

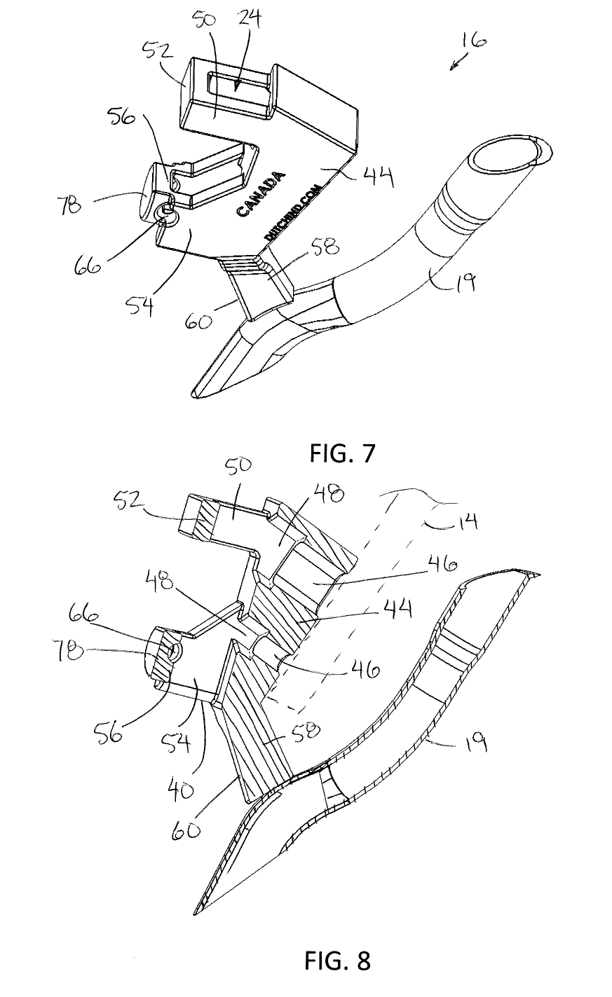

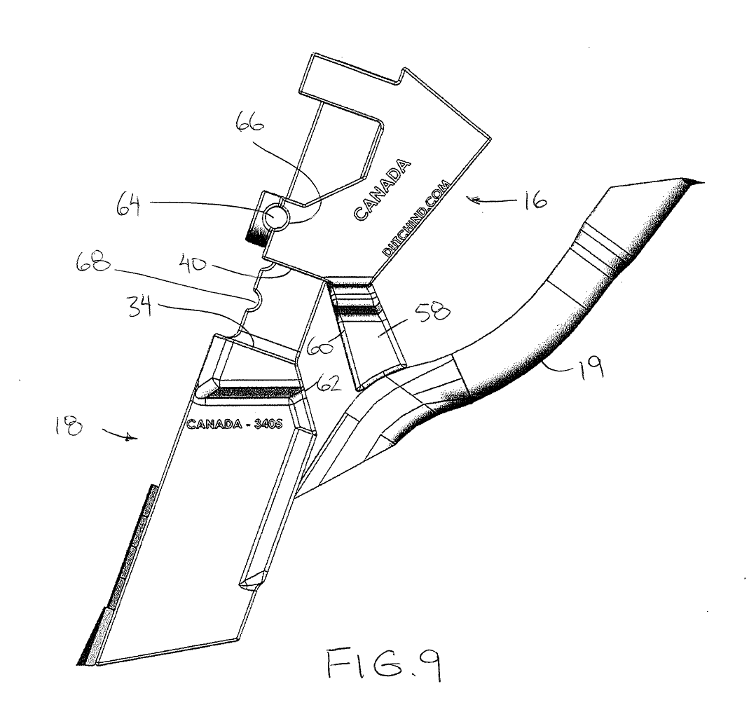

The upper shoulders of the lower portion of the tip body are adapted to be abutted against a lower mounting face 40 of the receptacle portion 24 of the opener body in an uppermost one of a plurality of different mounted positions of the tip body relative to the opener body as illustrated in FIGS. 1 through 4 and as described in further detail below.

The tip body further includes a plurality of wear resistant members 42 formed of carbide material which are mounted to cover a lower section of the leading edge 26 of the lower portion of the tip body.

The receptacle portion 24 of the opener body 16 generally comprises a sleeve structure defining a passage extending longitudinally therethrough which receives the upper portion of the tip body for longitudinal sliding movement therein to vary the height of the tip body 18 relative to the opener body 16 through a range of the different mounted positions. A rear boundary of the sleeve passage defines a mounting portion 44 of the opener body which has a flat rear face for abutment against of the leading face of the tool shank of the implement. An opposing front face of the mounting portion 44 is more upright than the rear face to define the rear boundary of the sleeve passage. A pair of fastener bores 46 extend through the mounting portion 44 for alignment with corresponding fastener apertures in the tool shank for bolting the opener body to the tool shank in a mounted position. A pair of counter bores 48 are formed at the forward end of the fastener bores 46 in which the inner diameter of the bore is increased to receive the enlarged heads of the bolts used for fastening the opener body to the shank. The counter bores permit the heads of the fasteners to be recessed inwardly into the body of the mounting portion 44 relative to the boundary of the sleeve passage so that the sleeve passage is unobstructed by the fasteners. The counter bores 40 may be formed with a hexagonal cross-section for receiving a hexagonal bolt head non-rotatably therein.

The sleeve structure is further defined by two upper arms 50 extending forwardly from laterally opposing sides of the mounting portion 44 of the body adjacent the top end thereof so as to be parallel to one another and spaced apart by a distance corresponding to the lateral width of the upper portion of the tip body which is received therebetween. An upper crossbar 52 is joined between the front ends of the upper arms 50 at the front side of the opener body at a location spaced forwardly from the front face of the mounting portion 44 by a distance suitable to receive the upper portion of the tip body therebetween. The upper arms 50 and the upper crossbar 52 define side boundaries and a forward boundary of the sleeve passage at the upper end of the opener body.

Similarly, the sleeve structure further includes two lower arms 54 protruding forwardly from laterally opposing sides of the mounting portion 44 near the bottom end thereof such that the lower arms are parallel and laterally spaced apart from one another by a distance suitable to receive the upper portion of the tip body therebetween. A lower crossbar 56 is connected between the forward ends of the lower arms 54 at a location spaced forwardly from the front face of the mounting portion by a distance suitable to receive the upper portion of the tip body therebetween. The lower arms 54 and the lower crossbar 56 define side boundaries and a forward boundary of the sleeve passage at the lower end of the receptacle portion 24 of the opener body.

The bottom of the lower arms 54 and the lower crossbar 56 lie in a common plane perpendicularly to the longitudinal axis of the sleeve passage so as to define the mounting face 40 that abuts the upper shoulders of the lower portion of the tip body in the uppermost mounted position of the tip body relative to the opener body.

The opener body 16 further includes a supporting portion 58 which is sloped to extend generally downwardly and rearwardly from the bottom of the mounting portion 40, rearwardly of the sleeve passage to mount the product delivery body 19 thereon at a location rearward of the tip body. As illustrated, the product delivery body comprises an elongate tube which is mounted in fixed relation at the bottom end of the supporting portion 58 of the body so as to remain in fixed relation to the opener body. The top end of the tube defining the product delivery body 19 is adapted for connection to a suitable product delivery tube of the implement for the delivery of a product therethrough from the implement into the furrow formed by the tip body. The bottom end of the tube forming the product delivery tube is located directly adjacent to the rear edge of the lower portion of the tip body at a location spaced upwardly from the bottom of the tip body when the new, unworn tip body is mounted in the uppermost mounted position relative to the opener body.

A front face 60 of the supporting portion 58 of the opener body is sloped downwardly and rearwardly from a rear of the mounting face 40 at the bottom of the receptacle 24. The tip body is shaped at the junction of the upper and lower portions to mate with the profile of the mounting face 40 and front face 60 of the opener body thereabove in the uppermost mounted position of the tip body relative to the opener body. More particularly, the lower portion of the tip body is shaped at the top end thereof such that the rear edge of the upper portion 22 is stepped forwardly in relation to the rear edge of the lower portion 20 to define a rear shoulder 62 therebetween which is sloped downwardly and rearwardly at the same orientation as the front face 60 of the supporting portion. In this manner the upper shoulders 34 of the tip body are adapted to mount against the mounting face 40, while the rear shoulder 62 is adapted to mount against the front face 60 of the supporting portion in the uppermost mounted position of the tip body relative to the opener body.

To retain the tip body at a desired mounted position relative to the opener body, a retainer pin 64 is provided for being received through a retainer aperture 66 which extends laterally through the opener body 66 generally at the junction of the lower arms 54 and the front crossbar 56. The pin 64 and aperture 66 each have a circular cross-section. The circular cross-section is penetrated laterally through the opener body so as to overlap only partway into the sleeve passage. In this manner when the pin 64 is received within the retainer aperture 66, a portion of the cross-section of the pin is received within the portion of the aperture extending through the lower crossbar, while a portion of the cross-section of the retainer pin 64 protrudes into the sleeve passage for being partly received into the upper portion of the tip body.

To receive the retainer pin therein in each of the mounted positions of the tip body relative to the opener body, the front face of the upper portion of the tip body is formed with a plurality of retainer slots 68 formed therein at evenly spaced apart positions in the longitudinal direction. Each retainer slots 68 comprises a semicircular shaped groove extending laterally across the full width of the tip body in which each groove is aligned with the retainer aperture 66 in a corresponding one of the mounted positions of the tip body relative to the opener body for receiving the pin therein.

In use when forming a furrow in the ground, the ground force is directed onto the tip body to urge the tip body upwardly and rearwardly, however upward sliding of the tip body relative to the opener body is prevented by the retainer pin being received within a selected one of the retainer slots 68 in the tip body. To isolate the pin from the shear forces, the shoulders of the lower portion of the tip body abut the mounting face 40 and front face 60 on the opener body in the uppermost position. In other mounted positions, suitable spacers 70 may be used as illustrated in FIG. 10.

Each spacer 70 comprises a collar having an aperture extending therethrough into which the upper portion of the tip of body can be slidably received such that the spacer 70 is retained on the tip body by extending about a full circumference of the upper portion of the tip body received therein. The spacer is slidably removable over the top end of the tip body when the tip body is separated from the opener body if the spacer is not to be used such as when the tip body is located in the uppermost mounted position of FIGS. 1 through 4. The spacers are generally identical in configuration to one another, each having a height in the axial direction which corresponds to the centre to centre spacing between adjacent ones of the retainer slots 68. Accordingly, regardless of the number of spacers mounted onto the tip body for abutment between the shoulders 34 on the tip body and the mounting face 40 of the opener body, one of the retainer slots 68 will be aligned with the retainer aperture 66 in each instance.

Each spacer 70 is shaped at both the upper and lower surfaces thereof to include a forward portion 72 lying perpendicularly to the longitudinal direction for mating with the mounting face 40 and the upper shoulders 34 respectively, and a rearward portion 74 which is sloped downwardly and rearwardly relative to the forward portion for mating with the rear shoulder 62 and the front face 60 of the supporting portion 58 respectively.

To fix the retainer pin 64 in a mounted position within the retainer aperture 66, the retainer pin is provided with an enlarged head at one end that has a mounting aperture pivotally receiving a latch ring 76 therein. The latch ring 76 is pivotal within the mounting aperture in the head of the retainer pin about an axis of the aperture which is oriented tangentially to the circumference of the pin. In this manner the latch ring 76 can be pivoted into a latching position lying within a plane which is parallel to the axis of the pin at a location along a forward side of the pin.

In this instance, the front face of the lower crossbar is shaped to define a protruding lug 78 having a maximum diameter which is approximately equal to the interior diameter of the latch ring 76. In this manner, when the retainer pin is fully received within the retainer aperture 66, the latch ring 76 can be pivoted forwardly in overlapping configuration across the front side of the lower crossbar into the latching position in which the protruding lug 78 is snuggly received within the latch ring 76 to retain the latch ring in the latched position, which in turn maintains the retainer pin 64 fixedly mounted within the retainer aperture, which in turn fixes the tip body 18 relative to the opener body 16. From the latched position, the latch ring 76 can be pivoted forwardly to be released from the lug 78 which then enables the retainer pin to be laterally slidably removed from the retainer aperture 66.

In use, the opener is initially configured in the uppermost position of the tip body relative to the opener body as shown in FIG. 1 through 4. As the tip body becomes worn with continued use, and the bottom end of the tip body wears away such that the tip body becomes shorter in overall length in the longitudinal direction, the user can release the retainer pin and slidably displace the tip body to the next adjacent mounted position relative to the opener body. Replacement of the retainer pin then allows continued use of the opener to form furrows in the ground while maintaining the bottom end of the tip body spaced well below the bottom end of the product delivery passage to prevent wearing and plugging of the bottom end of the product delivery tube.

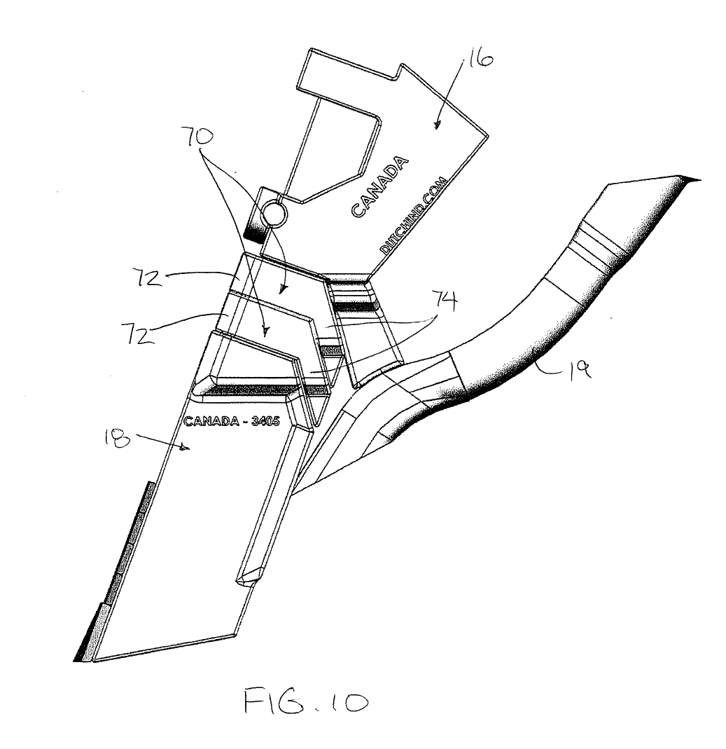

The opener can be used without additional spacers as shown in FIG. 9 in which the retainer pin resists upward movement of the tip body relative to the opener body; however, it is preferable to use the spacers in direct abutment between the tip body and the opener body to provide adequate support to the tip body. By locating the retainer pin to be only partially received within a lateral groove formed in the front face of the tip body, a larger portion of the retainer pin occupies the shear plane at the boundary of the sleeve structure slidably receiving the upper portion of the tip body therein so that the retainer pin is more resistant to shearing.

Furthermore, the grooves which only partially receive the cross-section of the retainer pin in each mounted position are less likely to cause jamming and wedging of the pin within the retainer aperture as a result of debris such that the retainer pin is more readily released from the opener body as compared to a retainer pin penetrated through a bore in the tip body. The retainer pin as described above is thus more readily replaced without the need for tools.

Further locating the retainer pin for cooperation between the opener body and an upper portion of the tip body at a location spaced above the knife shaped portion of the tip body, also isolates the retainer pin from significant wear.

To isolate the retainer pin from shear forces, one or more of the spacers 70 may optionally be inserted between the tip body shoulder 34 and the mounting face 40 of the opener body by slidably removing the tip body from the opener body, inserting the one or more spacers onto the upper portion of the tip body, and re-mounting the tip body onto the opener body. This configuration further reduces the opportunity for jamming of the retainer pin within the retainer aperture.

In further embodiments, the tip body may be configured in different shapes suited for forming different furrow profiles for depositing different materials into the ground. The product delivery body 19 in fixed relation to the opener body may form various configurations of product delivery passages therein suitable for delivering seed or granular fertilizer for example, or suitable for delivering liquid fertilizer in other embodiments for example.

Since various modifications can be made in my invention as herein above described, and many apparently widely different embodiments of same made, it is intended that all matter contained in the accompanying specification shall be interpreted as illustrative only and not in a limiting sense.

1. A furrow opener for an agricultural tillage implement having a plurality of tillage tool supporting shanks for being supported for movement across a ground surface in a forward working direction, the furrow opener comprising:
an opener body comprising a mounting portion adapted to be mounted onto one of the tillage tool supporting shanks of the implement;
a tip body supported on the opener body at a location which is downwardly and forwardly in relation to the mounting portion of the opener body so as to be adapted to form a furrow in the ground surface when displaced across the ground surface in the forward working direction; and
a product delivery passage on the opener body for connection to a product delivery tube of the implement for delivery of a product therethrough into the furrow formed by the tip body;
the tip body being coupled to the opener body so as to be adjustable in height relative to the opener body between a plurality of different mounted positions;
each mounted position corresponding to a different height of the tip body relative to the product delivery passage on the opener body.

2. The opener according to claim 1 wherein the tip body comprising a vertical knife shaped body.

3. The opener according to claim 2 wherein the knife shaped body comprises a pair of side surfaces which are flat and parallel to one another at opposing sides of the tip body and a pair of rear protrusions which protrude laterally outwardly from rear edges of the pair of side surfaces respectively.

4. The opener according to claim 1 wherein the knife shaped body comprises a pair of side surfaces which are flat and parallel to one another at opposing sides of the tip body and a pair of upper protrusions which protrude laterally outwardly from the pair of side surfaces respectively which are adapted to abut a corresponding face on the opener body in an uppermost one of the mounted positions of the tip body relative to the opener body.

5. The opener according to claim 1 wherein the opener body comprises a receptacle portion receiving an upper portion of the tip body longitudinally slidable therein between the different mounted positions of the tip body relative to the opener body, and wherein a rear wall of the receptacle includes fastener apertures therein so as to be adapted to be fastened to the tool shank therethrough.

6. The opener according to claim 1 wherein the opener body comprises a receptacle portion receiving an upper portion of the tip body longitudinally slidable therein between the different mounted positions of the tip body relative to the opener body and a mounting face at a bottom end of the receptacle, and wherein the tip body comprising an intermediate shoulder formed thereon which is adapted to abut the mounting face of the opener body in an uppermost one of the mounted positions of the tip body relative to the opener body.

7. The opener according to claim 1 wherein the opener body comprises a receptacle portion receiving an upper portion of the tip body longitudinally slidable therein between the different mounted positions of the tip body relative to the opener body, and wherein the opener body further comprises a supporting portion extending downwardly and rearwardly from the receptacle portion which supports the product delivery passage thereon.

8. The opener according to claim 1 further comprising:
the opener body including a receptacle portion receiving an upper portion of the tip body longitudinally slidable therein between the different mounted positions of the tip body relative to the opener body;
the tip body including a plurality of retainer slots formed at longitudinally spaced positions along an exterior surface of the upper portion of the tip body;
a retainer aperture extending through the opener body, the retainer aperture being aligned with a respective one of the retainer slots in each of the mounted positions of the tip body relative to the opener body; and
a retainer pin extending through the retainer aperture in the opener body such that at least a portion of the retainer pin is received within the respective retainer slot in the tip body in each of the mounted positions of the tip body relative to the opener body.

9. The opener according to claim 8 wherein a cross section of the pin is only partly received within the respective retainer slot in the tip body in each of the mounted positions of the tip body relative to the opener body.

10. The opener according to claim 8 wherein the retainer pin includes a latch member pivotally coupled at one end thereof for pivotal movement between a latched position in mating connection with a portion of the opener body so as to prevent sliding removal of the retainer pin from the retainer aperture and an unlatched position in which the retainer pin is slidably removable from the retainer aperture.

11. The opener according to claim 1 further comprising:
the opener body including a receptacle portion;
the tip body including (i) a lower portion adapted to form the furrow in the ground, (ii) an upper portion which extends longitudinally upward from the lower portion and which is adapted to be received within the receptacle portion of the opener body throughout the range of mounted positions of the tip body on the opener body, and (iii) an intermediate shoulder oriented transversely to the upper portion at a junction of the upper portion and the lower portion which is adapted to abut a corresponding mounting face of the opener body in an uppermost one of the mounted positions of the tip body relative to the opener body; and
a spacer adapted to be releasably mounted onto the upper portion of the tip body in abutment between the intermediate shoulder on the tip body and the mounting face of the opener body in one of the mounted positions of the tip body relative to the opener body which is different from the uppermost one of the mounted positions.

12. The opener according to claim 11 wherein the spacer comprises a collar which extends about the upper portion of the tip body and which is slidably removable over a top end of the upper portion of the tip body when the tip body is separated from the opener body.

13. A furrow opener for an agricultural tillage implement having a plurality of tillage tool supporting shanks for being supported for movement across a ground surface in a forward working direction, the furrow opener comprising:
an opener body comprising a mounting portion adapted to be mounted onto one of the tillage tool supporting shanks of the implement and a receptacle portion;
a tip body adapted to be supported on the opener body through a range of mounted positions corresponding to different heights of the tip body relative to the opener body;
the tip body comprising (i) a lower portion adapted to form a furrow in the ground surface when displaced across the ground surface in the forward working direction, (ii) an upper portion which extends longitudinally upward from the lower portion and which is adapted to be received within the receptacle portion of the opener body throughout the range of mounted positions of the tip body on the opener body, and (iii) an intermediate shoulder oriented transversely to the upper portion at a junction of the upper portion and the lower portion which is adapted to abut a corresponding mounting face of the opener body in an uppermost one of the mounted positions of the tip body relative to the opener body; and
a spacer adapted to be releasably mounted onto the upper portion of the tip body in abutment between the intermediate shoulder on the tip body and the mounting face of the opener body in one of the mounted positions of the tip body relative to the opener body which is different from the uppermost one of the mounted positions.

14. The opener according to claim 13 wherein the spacer comprises a collar which extends about the upper portion of the tip body and which is slidably removable over a top end of the upper portion of the tip body when the tip body is separated from the opener body.

15. A furrow opener for an agricultural tillage implement having a plurality of tillage tool supporting shanks for being supported for movement across a ground surface in a forward working direction, the furrow opener comprising:
an opener body comprising a mounting portion adapted to be mounted onto one of the tillage tool supporting shanks of the implement and a receptacle portion;
a tip body adapted to be supported on the opener body through a range of mounted positions corresponding to different heights of the tip body relative to the opener body;
the tip body comprising (i) a lower portion adapted to form a furrow in the ground surface when displaced across the ground surface in the forward working direction, (ii) an upper portion which extends longitudinally upward from the lower portion and which is adapted to be received within the receptacle portion of the opener body throughout the range of mounted positions of the tip body on the opener body, and (iii) a plurality of retainer slots formed at longitudinally spaced positions along an exterior surface of the upper portion of the tip body;
a retainer aperture extending through the opener body, the retainer aperture being aligned with a respective one of the retainer slots in each of the mounted positions of the tip body relative to the opener body; and
a retainer pin extending through the retainer aperture in the opener body such that a cross section of the pin is only partly received within the respective retainer slot in the tip body in each of the mounted positions of the tip body relative to the opener body.

16. The opener according to claim 15 wherein the retainer aperture extends laterally through the opener body perpendicularly to the forward working direction.

17. The opener according to claim 15 wherein the retainer slots are formed in a front face of the upper portion of the tip body.
